(19) United States
(12) Patent Application Publication
(10) Pub. No.: US 2025/0171913 A1
(43) Pub. Date: May 29, 2025

(54) STORAGE-STABLE SOLUTION COMPRISING HYPOCHLOROUS ACID AND/OR HYPOCHLORITE

(71) Applicant: LUNA-IP GMBH, Wien (AT)

(72) Inventors: Daniel HERZOG, Purkersdorf (AT); Philipp KUNZE, Wien (AT)

(21) Appl. No.: 18/837,419

(22) PCT Filed: Feb. 2, 2023
(86) PCT No.: PCT/AT2023/060028

§ 371 Date: Aug. 9, 2024

(30) Foreign Application Priority Data
Feb. 9, 2022 (AT) A 50077/2022
Mar. 8, 2022 (AT) A 50146/2022

(51) Int. Cl. C25B 1/26; A01N 25/02; A01N 59/00; A01P 1/00

(52) U.S. Cl. CPC C25B 1/26; A01N 25/02; A01N 59/00; A01P 1/00

(57) ABSTRACT

The present patent application relates to a method of producing a storage-stable aqueous solution comprising hypochlorous acid and/or hypochlorite, comprising the steps of:
a. introducing an aqueous NaCl solution into an electrolytic cell (1) which comprises a cathode compartment (2) and an anode compartment (3), which are separated from each other by a separator (4), wherein the aqueous NaCl solution is introduced into the cathode compartment (2) via a first feed line (5) and into the anode compartment (3) via a second feed line (6), and wherein the aqueous NaCl solution comprises more than 100 ppm NaCl,
b. applying a direct current to a cathode in the cathode compartment (2) and to an anode in the anode compartment (3) to produce a cathode solution in the cathode compartment (2) and an anode solution in the anode compartment (3), and
c. mixing a portion of the cathode solution with the aqueous NaCl solution before introducing it into the anode compartment (3) and/or with the anode solution in the anode compartment (3) and/or with the anode solution in a discharge line (7) associated with the anode compartment (3), or adding an NaOH solution into the anode compartment (3) and/or into a discharge line (7) associated with the anode compartment (3),
   in order to produce a storage-stable aqueous solution comprising hypochlorous acid and/or hypochlorite that has a pH value of 5 to 6 and can be discharged via the discharge line (7).

### TECHNICAL FIELD

The present invention relates to methods of producing storage-stable aqueous solutions which comprise hypochlorous acid and/or salts thereof.

### BACKGROUND OF THE INVENTION

Hypochlorous acid or salts thereof (hypochlorites), also referred to as active chlorine, can be produced by different methods. A widely used method involves electrolysis of an NaCl solution, wherein electrolytic cells are usually used. Since explosive gas mixtures (oxygen and chlorine gas at the anode and hydrogen at the cathode) can emerge during the electrolysis of NaCl solutions, a membrane or diaphragm, which separates the cell into an anode compartment and a cathode compartment, is located in the electrolytic cell. The membranes or, respectively, diaphragms used for this can be traversed only by small ions such as sodium and hydroxide ions so that there will be no mixing of the solutions emerging at the anode or, respectively, the cathode. As a result of this separation, an acidic, oxidizing solution with excellent disinfecting properties is formed in the anode compartment, and a basic, reducing solution is produced in the cathode compartment. The solution produced in the anode compartment is referred to as an anolyte, and the solution produced in the cathode compartment is referred to as a catholyte. The solutions produced using this method are also known as electrochemically activated (ECA) solutions.

The antimicrobial effectiveness of the anolyte solution is based on the interaction of the oxidative ions (hypochlorous acid), which have a relatively high redox potential, and the low pH value. ECA solutions have been shown to kill 99.99% of germs and thus to be more than 100 times more effective than conventional chlorine bleach, for example. Thanks to their non-selective antimicrobial effectiveness, they also do not contribute to the formation of resistance. The effectiveness of ECA solutions against bacteria, fungi, viruses, algae and spores has been scientifically proven. ECA solutions are therefore used, among other things, in drinking water treatment and for disinfecting medical equipment in hospitals, for example. ECA solutions are also used in plant cultivation and animal husbandry. In certain countries, ECA solutions are also utilized in the production of food, whereby ECA solutions can come into direct as well as indirect contact with food.

In addition to their use as disinfectants, the application of ECA solutions for treating wounds and burns has proven to be very effective so that they have also proven their worth in the medical treatment of humans and animals.

The versatile use of ECA solutions in a wide variety of areas demonstrates the usability of aqueous solutions comprising hypochlorous acid. However, it has been shown that the solutions produced using previous methods have a relatively low storage stability so that the concentration of hypochlorous acid or, respectively, hypochlorite in such solutions becomes significantly lower over time. Due to this decrease in concentration, the solution loses effectiveness and can no longer be used appropriately.

It is therefore an object of the present invention to provide a method which allows to produce a storage-stable aqueous solution comprising hypochlorous acid and/or hypochlorite.

### SUMMARY OF THE INVENTION

The present invention therefore relates to a method of producing a storage-stable aqueous solution comprising hypochlorous acid and/or hypochlorite, comprising the steps of:
a. introducing an aqueous NaCl solution into an electrolytic cell (1) which comprises a cathode compartment (2) and an anode compartment (3), which are separated from each other by a separator (4), wherein the aqueous NaCl solution is introduced into the cathode compartment (2) via a first feed line (5) and into the anode compartment (3) via a second feed line (6), and wherein the aqueous NaCl solution comprises more than 100 ppm NaCl,
b. applying a direct current to a cathode in the cathode compartment (2) and to an anode in the anode compartment (3) to produce a cathode solution in the cathode compartment (2) and an anode solution in the anode compartment (3), and
c. mixing a portion of the cathode solution with the aqueous NaCl solution before introducing it into the anode compartment (3) and/or with the anode solution in the anode compartment (3) and/or with the anode solution in a discharge line (7) associated with the anode compartment (3), or adding an NaOH solution into the anode compartment (3) and/or into a discharge line (7) associated with the anode compartment (3),
   in order to produce a storage-stable aqueous solution comprising hypochlorous acid and/or hypochlorite that has a pH value of 5 to 6 and can be discharged via the discharge line (7).

It has surprisingly been shown that the electrolysis of an NaCl solution which comprises more than 100 ppm NaCl enables the production of a storage-stable solution comprising hypochlorous acid and/or hypochlorite, if the pH value of the solution produced is adjusted to 5 to 6.

A further aspect of the present invention relates to a method of producing a storage-stable aqueous solution comprising hypochlorous acid and/or hypochlorite, comprising the steps of:
a. introducing an aqueous NaCl solution into an electrolytic cell which comprises a cathode compartment and an anode compartment, which are separated from each other by a separator, wherein the aqueous NaCl solution is introduced into the cathode compartment via a first feed line and into the anode compartment via a second feed line, and wherein the aqueous NaCl solution comprises more than 100 ppm NaCl,
b. applying a direct current to a cathode in the cathode compartment and to an anode in the anode compartment to produce a cathode solution in the cathode compartment and an anode solution in the anode compartment, and
c. mixing a portion of the cathode solution with the aqueous NaCl solution before introducing it into the anode compartment and/or with the anode solution in the anode compartment and/or with the anode solution in a discharge line associated with the anode compartment, or adding an NaOH solution into the anode compartment and/or into a discharge line associated with the anode compartment,
   in order to produce a storage-stable aqueous solution comprising hypochlorous acid and/or hypochlorite that has a pH value of 5 to 6 and can be discharged via the discharge line, wherein the introduction of the aqueous NaCl solution into the electrolytic cell and the discharge of the storage-stable aqueous solution from the electrolytic cell occur at a flow rate of 0.1 m/s to 2 m/s.

It has surprisingly been shown that the flow rate selected in the electrolysis process according to the invention can influence the stability of the aqueous solution produced. This means that, if a certain flow rate is selected at which the electrolysis is performed, this can lead to a stable product which has a lower degradation rate of the hypochlorous acid or, respectively, the hypochlorite.

The object according to the invention can also be achieved by a method of producing a storage-stable aqueous solution comprising hypochlorous acid and/or hypochlorite, comprising the steps of:
a. introducing an aqueous NaCl solution into an electrolytic cell which comprises a cathode compartment and an anode compartment, which are separated from each other by a membrane, wherein the aqueous NaCl solution is introduced into the cathode compartment via a first feed line and into the anode compartment via a second feed line, and wherein the aqueous NaCl solution comprises more than 100 ppm NaCl and has an electrical conductivity of less than 30 mS/cm, preferably less than 5 mS/cm,
b. applying a direct current to a cathode in the cathode compartment and to an anode in the anode compartment to produce a cathode solution in the cathode compartment and an anode solution in the anode compartment, and
c. mixing a portion of the cathode solution
   with the aqueous NaCl solution before introducing it into the anode compartment and/or
   with the anode solution in the anode compartment and/or
   with the anode solution in a discharge line associated with the anode compartment, or
adding an NaOH solution
   into the anode compartment and/or
   into a discharge line associated with the anode compartment, in order to produce a storage-stable aqueous solution comprising hypochlorous acid and/or hypochlorite that has a pH value of 5 to 6 and can be discharged via the discharge line.

Especially the pH value of the solution produced using the method according to the invention influences the stability of the hypochlorous acid and/or hypochlorite present therein. The greatest stability could be observed at a pH value of 5 to 6. Therefore, the pH value of the aqueous solution according to the invention, which has been produced during electrolysis, is adjusted to 5 to 6. The adjustment of the pH value can be done in a variety of ways.

Firstly, the pH value can be adjusted by introducing part of the cathode solution (catholyte) into the anode compartment. The catholyte formed during electrolysis has a high pH value (more than 10) due to the formation of hydroxide ions. Such a high pH value allows the pH value of the anolyte in the anode compartment to be increased to 5 to 6. Without this supply, the pH value of the anolyte would fall below 4. The supply of the catholyte into the anolyte can be done in a variety of ways, wherein it is particularly preferred to establish a connection between the cathode and anode compartments and to control the supply of the catholyte into the anode compartment via a valve, which is preferably pH-controlled. Appropriate devices are sufficiently described in the prior art (see, e.g., EP 1 074 515).

Alternatively, the catholyte can be brought into contact with the aqueous NaCl solution before it is introduced into the anode compartment. This is accomplished, for example, in that, prior to the introduction into the anode compartment, part of the catholyte is mixed with the aqueous NaCl solution, which is subsequently introduced into the anode compartment. The pH value of the anolyte is thus adjusted via the feed of the aqueous NaCl solution. The amount of catholyte that is brought into contact with the aqueous NaCl solution is preferably controlled via a valve which is coupled to a sensor that measures the pH value of the storage-stable aqueous solution according to the invention that has been discharged from the anode compartment.

It has been shown according to the invention that it is also possible to adjust the pH value of the storage-stable aqueous solution according to the invention by mixing the anolyte with a portion of the catholyte. In doing so, a certain amount of catholyte is added to the anolyte, which is sufficient for adjusting the pH value of the discharged anolyte, the aqueous solution according to the invention, to 5 to 6. In addition to the catholyte or as an alternative, the anolyte can be mixed with an aqueous solution containing NaOH and/or KOH in order to adjust the pH value of the final product to 5 to 6.

Alternatively, the pH value can also be adjusted to the target value by adding an NaOH solution into the anode compartment and/or into a discharge line associated with the anode compartment. In doing so, the NaOH solution preferably has an NaOH concentration of 0.5 to 5%, preferably of 1 to 5%.

The anode and the cathode preferably comprise or consist of metals such as titanium, with the anode additionally comprising an electrocatalytically active layer (for the oxidation of chloride ions) containing metal oxides such as, e.g., ruthenium oxide, iridium oxide, titanium oxide or mixtures thereof.

The anode compartment and the cathode compartment of the electrolytic cell used according to the invention are separated by a separator. The separator separates the solution in one compartment from the solution in the other compartment, with migration of selected ions between the compartments being possible. Semipermeable diaphragms or ion-selective membranes can be used as separators, for example. The separators used can comprise a ceramic based on metal oxides such as aluminium oxide, optionally containing other oxides such as zirconium oxide and yttrium oxide. Ion-selective membranes can, for example, comprise perfluorinated hydrocarbon optionally containing ionic sulfonate groups. Well-known membranes are, for example, those from DuPont, which are sold under the trade name Nafion®.

At a pH value of over 7, an increased amount of chlorate forms in solutions which comprise hypochlorous acid or, respectively, hypochlorite, which impairs the further stability of such solutions and can exhibit a toxic effect at higher concentrations. However, an increased formation of chlorine gas, which can be expelled from the solution, becomes apparent below a pH value of 6, whereby the stability of the solution according to the invention is also negatively affected.

A further aspect of the present invention relates to a storage-stable aqueous solution comprising hypochlorous acid and/or hypochlorite, producible according to a method of the present invention.

### BRIEF DESCRIPTION OF THE FIGURES

FIG. 1 shows the schematic structure of a plant for producing the aqueous solution according to the invention.

### DESCRIPTION OF THE EMBODIMENTS

Using the method according to the invention, storage-stable aqueous solutions comprising hypochlorous acid and/or hypochlorite can be produced. “Storage-stable” with regard to the aqueous solution according to the invention means that the concentration of the hypochlorous acid or, respectively, the hypochlorite in the solution decreases after electrolysis at room temperature (approx. 20° C.) by less than 30% and by at most 10 to 30% over an extended period of, for example, 6 to 12 months. It has been shown that, in solutions produced using conventional methods not according to the invention, the concentration of the hypochlorous acid or, respectively, the hypochlorite sometimes decreases by at least 50% within days or weeks.

According to the invention, such solutions cannot be described as storage-stable. Adequate storage stability of the solution according to the invention can be determined according to the invention in a “rapid method” by determining its content of hypochlorous acid or, respectively, hypochlorite after storage at a temperature of 54° C. If the content of hypochlorous acid or, respectively, hypochlorite is more than 50% of the initial value (measured immediately after its production) after 14 days of storage, the solution can be described as storage-stable.

Chlorine can occur in several forms when dissolved in water or, respectively, in aqueous solutions. The three different forms OCl⁻, HOCl and Cl₂ are subsumed under the term “chlorine that is active” or “active chlorine”. The exact concentration of the individual forms of this free available chlorine (FAC) depends, among other things, on the pH value of the water or, respectively, the aqueous solution and can be determined as a “rapid method” using the method according to DIN EN ISO 7939-1 (see, e.g., https://echa.europa.eu/documents/10162/9e0ceb55-c2b2-8c43-9c93-26a758b6a058). This is a titrimetric method in which the free available chlorine is brought into contact with N,N-diethyl-1,4-phenylenediamine (DPD), whereby a red compound at a pH value of 6.2 to 6.5 emerges. The titration is carried out with a standard solution of ammonium iron (II) sulfate until the red colour disappears.

During storage, the pH value of the solutions prepared according to the invention can fall below 5. This has no influence on the storage stability itself, as it has been shown that the pH value immediately after the preparation of the solution according to the invention is crucial. At this point, it should range between 5 and 6. If the pH value is higher than 6 or, respectively, lower than 5, this has a negative impact on the storage stability.

The storage stability has various advantages. Aqueous solutions comprising hypochlorous acid and/or hypochlorite, which are produced using conventional methods, have to be transported from the production site to the place of use in a short time due to their low storage stability. Alternatively, the solutions are produced on site and used immediately afterwards. This means that a production facility is required at each place of use. Using the method according to the invention, solutions are produced that are stable for months. This results in enormous logistical advantages and also opens up new areas of application (e.g., medical use for end users).

The electrolytic cell used according to the invention is operated with a voltage of 5 to 40 volts, preferably 10 to 30 volts, and an amperage of 40 to 1000 amperes, preferably 50 to 600 amperes. It has been shown that the formation of the hypochlorous acid or, respectively, the hypochlorite proceeds particularly well in those ranges.

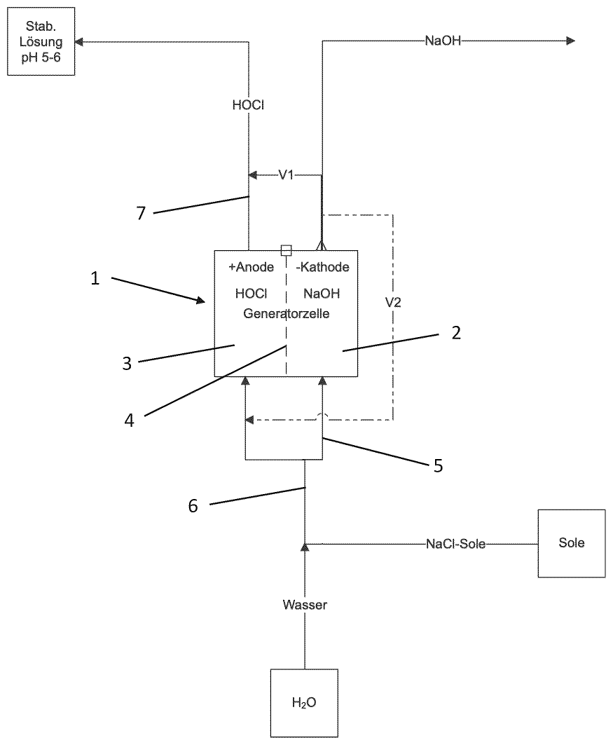

In FIG. 1, the schematic structure of a plant suitable for producing the aqueous solution according to the invention is shown. In this case, water is first mixed with a preferably saturated NaCl solution and is introduced into the cathode compartment 2 or, respectively, the anode compartment 3 of the electrolytic cell 1 via the lines 5 and 6. The anolyte from which the solution according to the invention is obtained and which comprises hypochlorous acid or, respectively, hypochlorite is removed from the anode compartment via the discharge line 7. V1 and V2 represent lines by means of which catholyte can be supplied from the cathode compartment either into the discharge line 7 and/or into the feed line 6 in order to adjust the pH value of the anolyte.

According to a particularly preferred embodiment of the present invention, the aqueous NaCl solution has an electrical conductivity of less than 30 mS/cm, preferably of 1 to 30 mS/cm, even more preferably of 5 to 30 mS/cm, even more preferably of 10 to 30 mS/cm.

According to a further preferred embodiment of the present invention, the aqueous NaCl solution has an electrical conductivity of 1 to 5 mS/cm, preferably of 1.5 to 4.5 mS/cm, even more preferably of 2 to 4 mS/cm, even more preferably of 2.5 to 4 mS/cm.

The stability of hypochlorous acid or, respectively, hypochlorite in an aqueous solution depends on the electrical conductivity. The higher said conductivity, the more unstable the solution becomes with respect to hypochlorous acid or, respectively, hypochlorite. The lowest range of the electrical conductivity is defined by the minimum concentration of 100 ppm NaCl in the solution to be electrolyzed. It has surprisingly been shown that the method according to the invention is suitable both for the electrolysis of NaCl solutions with a high salt concentration (with an electrical conductivity of up to 30 mS/cm) and for the electrolysis of NaCl solutions with a low salt concentration (with an electrical conductivity of up to 5 mS/cm) in order to produce a storage-stable aqueous solution comprising hypochlorous acid and/or hypochlorite.

The electrical conductivity is measured using known methods (such as in accordance with ISO 7888) at a temperature of approx. 22° C.

Depending on the electrical conductivity of the NaCl solution used, the latter comprises different NaCl concentrations and evaporation residues.

According to a preferred embodiment of the present invention, the aqueous NaCl solution comprises 2000 to 15000 ppm, preferably 3000 to 15000 ppm, even more preferably 4000 to 12000 ppm, even more preferably 5000 to 10000 ppm, of NaCl.

According to a particularly preferred embodiment of the present invention, the aqueous NaCl solution has an evaporation residue of 2 to 15 g/l, preferably of 3 to 15 g/l, even more preferably of 5 to 15 g/l, even more preferably of 5 to 10 g/l.

According to a further preferred embodiment of the present invention, the aqueous NaCl solution comprises 200 to 2000 ppm, preferably 300 to 1500 ppm, even more preferably 300 to 1000 ppm, even more preferably 300 to 700 ppm, of NaCl.

The NaCl solution which is used for electrolysis and introduced into the anode and cathode compartments preferably comprises 200 to 2000 ppm NaCl. The relatively small amount of NaCl in the electrolysis solution has the advantage that the solution according to the invention produced therewith, which comprises hypochlorite or, respectively, hypochlorous acid, is also low in NaCl. This is particularly advantageous with regard to the corrosiveness of the solution towards, for example, iron or ferrous objects. It has actually been shown that the solution produced according to the invention has a significantly lower corrosiveness than comparable solutions from the prior art which have been produced using other methods.

According to a preferred embodiment of the present invention, the aqueous NaCl solution has an evaporation residue of 1200 to 2000 mg/l, preferably of 1300 to 1900 mg/l, even more preferably of 1400 to 1800 mg/l.

The evaporation residue, which can be determined by evaporating (i.e., by removing the volatile compounds such as water) one litre of the aqueous NaCl solution, indicates the amount of non-volatile compounds, such as salts, in the solution. Since the stability of the aqueous solution according to the invention can be influenced by the amount of ions present, the evaporation residue in the aqueous NaCl solution should ideally not exceed a certain concentration.

According to a particularly preferred embodiment of the present invention, the aqueous NaCl solution is prepared by mixing a saturated aqueous NaCl solution and water, the water having a conductivity of less than 2 mS/cm, preferably of less than 1.5 mS/cm, even more preferably of less than 1 mS/cm.

The NaCl solution which is introduced into the electrolytic cell is preferably prepared by mixing a saturated aqueous NaCl solution and water. The water used for this should also have a low electrical conductivity to prevent the total conductivity from exceeding 5 mS/cm. In a particularly preferred embodiment, the water used for this can be deionized or distilled.

According to a preferred embodiment of the present invention, the water used for preparing the aqueous NaCl solution from a saturated NaCl solution has an electrical conductivity of between 0.1 and 2 mS/cm, preferably of between 0.2 and 1.5 mS/cm, even more preferably of between 0.4 and 1 mS/cm.

According to a further preferred embodiment of the present invention, the water has an evaporation residue of 5 to 500 mg/l, preferably of 5 to 300 mg/l, even more preferably of 10 to 250 mg/l.

According to a preferred embodiment of the present invention, the aqueous NaCl solution and/or the water has/have a pH value of 6.8 to 9.5, preferably of 7 to 9.2.

According to a particularly preferred embodiment of the present invention, the aqueous NaCl solution and/or the water has/have a carbonate concentration, i.e., a concentration of HCO₃⁻, of 10 to 500 ppm, preferably of 20 to 400 ppm, even more preferably of 30 to 300 ppm, even more preferably of 40 to 250 ppm.

It has surprisingly been shown that the carbonate hardness (expressed as the concentration of HCO₃⁻) of the aqueous NaCl solution introduced into the anode or, respectively, cathode compartment, or of the water with which the aqueous NaCl solution is prepared, can have an impact on the stability of the aqueous solution according to the invention. The carbonate hardness (CH) is the proportion of alkaline earth ions that are bound to carbonates (CO₃²⁻) and hydrogen carbonates (HCO₃⁻) and are dissolved in water.

According to a preferred embodiment of the present invention, the aqueous NaCl solution comprises less than 0.3 ppm, preferably less than 0.3 ppm, even more preferably less than 0.2 ppm, of copper ions, nickel ions and/or iron ions.

The content of metal ions, in particular the content of copper ions, nickel ions and iron ions, also has an effect on the stability of hypochlorous acid or, respectively, hypochlorite in aqueous solutions. If their concentration is below certain thresholds, the storage stability of the aqueous solutions produced according to the invention increases even further.

According to a preferred embodiment of the present invention, the aqueous NaCl solution comprises less than 0.02 ppm, preferably less than 0.01 ppm, of nitrate ions and/or nitrite ions.

It is advantageous if the aqueous NaCl solution has a small proportion of nitrate ions and/or nitrite ions in order to obtain a stable electrolysis product.

According to a further preferred embodiment of the present invention, the aqueous NaCl solution comprises less than 500 ppm, preferably less than 400 ppm, even more preferably less than 300 ppm, of sulfate ions, phosphate ions and/or orthosilicate ions.

The stability of the aqueous solution according to the invention can be increased once more if the aqueous NaCl solution comprises less than 500 ppm of sulfate ions, phosphate ions and/or orthosilicate ions.

According to yet another preferred embodiment of the present invention, the aqueous NaCl solution comprises less than 50 ppm, preferably less than 40 ppm, even more preferably less than 30 ppm, even more preferably less than 20 ppm, of calcium ions and/or magnesium ions.

It has been shown that too high a concentration of calcium or magnesium ions in the aqueous NaCl solution can lead to a product which has a lower stability.

According to a particularly preferred embodiment of the present invention, the aqueous NaCl solution comprises 20 to 200 ppm, preferably 50 to 100 ppm, of an inorganic buffer.

It has surprisingly been shown that the addition of an inorganic buffer substance to the NaCl solution that is used has a positive effect on the storage stability of the solution according to the invention, increasing it even further.

According to a further preferred embodiment of the present invention, the inorganic buffer comprises hydrogen carbonate. The electrolysis solution is preferably mixed with 10 to 500 ppm, preferably 20 to 400 ppm, even more preferably 30 to 300 ppm, even more preferably 40 to 250 ppm, of carbonate ions in the form of, for example, sodium hydrogen carbonate.

Especially the use of carbonates, such as hydrogen carbonates, demonstrated positive effects on the storage stability, with sodium hydrogen carbonate being used preferably.

According to a particularly preferred embodiment of the present invention, the introduction of the aqueous NaCl solution into the electrolytic cell and the discharge of the storage-stable aqueous solution from the electrolytic cell occur at a flow rate of 0.2 m/s to 1.8 m/s, preferably of 0.2 m/s to 1.5, even more preferably of 0.2 m/s to 1.2, even more preferably of 0.2 m/s to 1 m/s.

In addition, the flow rate selected in the electrolysis process according to the invention influences the stability of the aqueous solution produced. This means that, if a certain flow rate is selected at which the electrolysis is performed, this can lead to an even more stable product which has a lower degradation rate of the hypochlorous acid or, respectively, the hypochlorite.

The electrolytic cell is preferably brought to a temperature of 2° C. to 20° C., even more preferably of 3° C. to 15° C., even more preferably of 5° C. to 10° C., during the method according to the invention.

The cooling of the electrolytic cell and thus of the anolyte or, respectively, catholyte contained therein also leads to a more stable final product and a lower chlorate concentration in the product that has been produced. Alternatively or additionally, the saline solution fed into the cathode and anode compartments can also be brought to a temperature of 2° C. to 20° C., even more preferably of 3° C. to 15° C., even more preferably of 5° C. to 10° C., before it is introduced. The temperature in the electrolytic cell can be reduced accordingly by continuously supplying a cooled saline solution. It would thus also be possible to refrain from cooling the electrolytic cell.

According to a preferred embodiment of the present invention, the molar ratio between chlorate ions and hypochlorous acid and/or hypochlorite in the storage-stable solution immediately after its production and/or discharge from the electrolytic cell is less than 1:50, preferably less than 1:60, even more preferably less than 1:80.

A further aspect of the present invention relates to a storage-stable aqueous solution producible using a method according to the invention.

According to a preferred embodiment of the present invention, the storage-stable solution has an electrical conductivity of less than 4 mS/cm, preferably of less than 3 mS/cm, even more preferably of less than 2.5 mS/cm.

According to a further preferred embodiment of the present invention, the storage-stable solution has an electrical conductivity of 0.5 to 4 mS/cm, preferably of 1 to 3 mS/cm, even more preferably of 1.2 to 3 mS/cm, even more preferably of 1.4 to 2.5 mS/cm.

The conductivity of the storage-stable solution is usually lower than that of the aqueous NaCl solution which is introduced into the anode or, respectively, cathode compartment. Because of the electrolysis, chlorine, among other things, arises from the chloride ions in the anode compartment, which chlorine is expelled from the anolyte during the electrolysis. As a result, ions are removed from the system.

According to yet another preferred embodiment of the present invention, the storage-stable solution comprises between 50 and 1500 ppm, preferably between 100 and 1000, even more preferably between 150 and 800, even more preferably between 200 and 600 ppm, of hypochlorous acid and/or hypochlorite.

Using the method according to the invention, it is possible to produce a stable aqueous solution which comprises between 50 and 1500 ppm of hypochlorous acid and/or hypochlorite.

According to a further preferred embodiment of the present invention, the ratio between hypochlorous acid and/or hypochlorite and chloride ions in the storage-stable solution is 1:1.2 to 1:2.8, preferably 1:1 to 1:1.5 to 1:2.5, even more preferably 1:1.7 to 1:2.1.

Using the method according to the invention, a storage-stable solution is produced which preferably exhibits these ratios between hypochlorous acid and/or hypochlorite and chloride ions. During storage of the solution, this ratio can change over time due to the degradation of the hypochlorous acid or, respectively, the hypochlorite, what is crucial, however, is that this ratio prevails immediately after the electrolysis. This ratio also has a positive effect on storage stability.

According to a preferred embodiment of the present invention, the molar ratio between chlorate ions and hypochlorous acid and/or hypochlorite in the storage-stable solution is less than 1:10, preferably less than 1:20, even more preferably less than 3:100.

According to a further preferred embodiment of the present invention, the molar ratio between chlorate ions and hypochlorous acid and/or hypochlorite in the storage-stable solution increases from less than 1:60 to a maximum of 1:10 after 18 months of storage at 22° C.

It has surprisingly been shown that the solution according to the invention or, respectively, the solution producible using the method according to the invention has a relatively low chlorate content immediately after its production. Using methods known from the prior art, solutions are produced which have a relatively high chlorate content already at the beginning of storage, i.e., immediately after their production. Moreover, it has become apparent that the solution according to the invention or, respectively, the solution producible using the method according to the invention surprisingly still has a comparatively low chlorate content even after 18 months of storage.

According to a particularly preferred embodiment of the present invention, the storage-stable aqueous solution comprises chlorate at a concentration of less than 50 ppm, preferably of less than 40 ppm, even more preferably of less than 30 ppm, even more preferably of less than 25 ppm, even more preferably of less than 20 ppm.

In solution, hypochlorous acid or, respectively, hypochlorite disproportionates over time to form chlorate and chloride. Due to the measures taken during the production of the aqueous solution according to the invention, the concentration of chlorate is relatively low in comparison to solutions produced using conventional methods, wherein the degradation of hypochlorous acid or, respectively, hypochlorite occurs quickly. At high concentrations, chlorate has toxic effects, whereby a therapeutic use, for example, would be limited. Upon production and also during storage, the solution according to the invention always has a chlorate content of less than 50 ppm.

For the shelf life of the solution according to the invention, it has become apparent that a quantitative ratio of chlorate to FAC of less than 3.5 during production or immediately thereafter is particularly advantageous, since hypochlorous acid or, respectively, hypochlorite is degraded least at this ratio.

According to a preferred embodiment of the present invention, the storage-stable aqueous solution has a pH value of 4 to 6.

Immediately after production of the solution according to the invention, the pH value of the solution can decrease. It has surprisingly been shown that the initial pH value immediately after production is important for storage stability.

According to a particularly preferred embodiment of the present invention, the storage-stable aqueous solution comprises less than 0.3 ppm, preferably less than 0.2 ppm, of copper ions, nickel ions and/or iron ions.

According to a preferred embodiment of the present invention, the storage-stable aqueous solution comprises less than 0.1 ppm, preferably less than 0.05 ppm, even more preferably less than 0.01 ppm, of nitrate ions and/or nitrite ions.

According to a further preferred embodiment of the present invention, the storage-stable aqueous solution comprises less than 500 ppm, preferably less than 400 ppm, even more preferably less than 300 ppm, of sulfate ions, phosphate ions and/or orthosilicate ions.

According to a particularly preferred embodiment of the present invention, the storage-stable aqueous solution comprises less than 50 ppm, preferably less than 40 ppm, even more preferably less than 30 ppm, even more preferably less than 20 ppm, of calcium ions and/or magnesium ions.

According to a preferred embodiment of the present invention, the storage-stable aqueous solution has a redox potential of 1,000 to 1,500 mV, preferably of 1,100 to 1,400 mV, even more preferably of 1,150 to 1,300 mV.

According to a particularly preferred embodiment of the present invention, the storage-stable aqueous solution has an evaporation residue of 200 to 1,500 mg/l, preferably of 500 to 1,250 mg/l, even more preferably of 600 to 1,200 mg/l.

The stable solution according to the invention can be used for all purposes like known solutions comprising hypochlorous acid and hypochlorite, in particular as a disinfectant, for water disinfection, surface disinfection, wound disinfection, wound healing, plant cultivation, and the like.

Furthermore, the present invention is described by the following embodiments and examples:

1. A method of producing a storage-stable aqueous solution comprising hypochlorous acid and/or hypochlorite, comprising the steps of:
a. introducing an aqueous NaCl solution into an electrolytic cell (1) which comprises a cathode compartment (2) and an anode compartment (3), which are separated from each other by a separator (4), wherein the aqueous NaCl solution is introduced into the cathode compartment (2) via a first feed line (5) and into the anode compartment (3) via a second feed line (6), and wherein the aqueous NaCl solution comprises more than 100 ppm NaCl and has an electrical conductivity of less than 5 mS/cm,
b. applying a direct current to a cathode in the cathode compartment (2) and to an anode in the anode compartment (3) to produce a cathode solution in the cathode compartment (2) and an anode solution in the anode compartment (3), and
c. mixing a portion of the cathode solution with the aqueous NaCl solution before introducing it into the anode compartment (3) and/or with the anode solution in the anode compartment (3) and/or with the anode solution in a discharge line (7) associated with the anode compartment (3),
   in order to produce a storage-stable aqueous solution comprising hypochlorous acid and/or hypochlorite that has a pH value of 5 to 6 and can be discharged via the discharge line (7).
   2. A method according to embodiment 1, characterized in that the aqueous NaCl solution has an electrical conductivity of 1 to 5 mS/cm, preferably of 1.5 to 4.5 mS/cm, even more preferably of 2 to 4 mS/cm, even more preferably of 2.5 to 4 mS/cm.
   3. A method according to embodiment 1 or 2, characterized in that the aqueous NaCl solution comprises 200 to 2000 ppm, preferably 300 to 1500 ppm, even more preferably 300 to 1000 ppm, even more preferably 300 to 700 ppm, of NaCl. 4. A method according to any of embodiments 1 to 3, characterized in that the aqueous NaCl solution has an evaporation residue of 1200 to 2000 mg/l, preferably of 1300 to 1900 mg/l, even more preferably of 1400 to 1800 mg/l.
   5. A method according to any of embodiments 1 to 4, characterized in that the aqueous NaCl solution is prepared by mixing a saturated aqueous NaCl solution and water, the water having a conductivity of less than 2 mS/cm, preferably of less than 1.5 mS/cm, even more preferably of less than 1 mS/cm.
   6. A method according to embodiment 5, characterized in that the water has an electrical conductivity of between 0.1 and 2 mS/cm, preferably of between 0.2 and 1.5 mS/cm, even more preferably of between 0.4 and 1 mS/cm.
   7. A method according to embodiment 5 or 6, characterized in that the water has an evaporation residue of 5 to 500 mg/l, preferably of 5 to 300 mg/l, even more preferably of 10 to 250 mg/l.
   8. A method according to any of embodiments 1 to 7, characterized in that the aqueous NaCl solution and/or the water has/have a pH value of 6.8 to 9.5, preferably of 7 to 9.2.
   9. A method according to any of embodiments 1 to 8, characterized in that the aqueous NaCl solution and/or the water has/have 10 to 500 ppm, preferably 20 to 400 ppm, even more preferably 30 to 300 ppm, even more preferably 40 to 250 ppm, of carbonate ions.
   10. A method according to any of embodiments 1 to 9, characterized in that the aqueous NaCl solution comprises less than 0.3 ppm, preferably less than 0.25 ppm, even more preferably less than 0.2 ppm, of copper ions, nickel ions and/or iron ions, and/or less than 0.02 ppm, preferably less than 0.01 ppm, of nitrate ions and/or nitrite ions, and/or less than 500 ppm, preferably less than 400 ppm, even more preferably less than 300 ppm, of sulfate ions, phosphate ions and/or orthosilicate ions, and/or less than 50 ppm, preferably less than 40 ppm, even more preferably less than 30 ppm, even more preferably less than 20 ppm, of calcium ions and/or magnesium ions.
   11. A method according to any of embodiments 1 to 10, characterized in that the aqueous NaCl solution comprises 20 to 200 ppm, preferably 50 to 100 ppm, of an inorganic buffer.
   12. A method according to embodiment 11, characterized in that the inorganic buffer comprises hydrogen carbonate.
   13. A method according to any of embodiments 1 to 12, characterized in that the introduction of the aqueous NaCl solution into the electrolytic cell (1) and the discharge of the storage-stable aqueous solution from the electrolytic cell (1) occur at a flow rate of 0.1 m/s to 1 m/s, preferably of 0.2 m/s to 1.0 m/s.
   14. A method according to any of embodiments 1 to 13, characterized in that the electrolytic cell (1) is brought to a temperature of 2° C. to 20° C., preferably of 3° C. to 15° C., even more preferably of 5° C. to 10° C., during the method.
   15. A storage-stable aqueous solution producible using a method according to any of embodiments 1 to 14.
   16. A storage-stable aqueous solution according to embodiment 15, characterized in that the storage-stable solution has an electrical conductivity of less than 4 mS/cm, preferably of less than 3 mS/cm, even more preferably of less than 2.5 mS/cm.
   17. A storage-stable aqueous solution according to embodiment 15 or 16, characterized in that the storage-stable solution has an electrical conductivity of 0.5 to 4 mS/cm, preferably of 1 to 3 mS/cm, even more preferably of 1.2 to 3 mS/cm, even more preferably of 1.4 to 2.5 mS/cm.
   18. A storage-stable aqueous solution according to any of embodiments 15 to 17, characterized in that the storage-stable solution comprises between 50 and 1500 ppm, preferably between 100 and 1000, even more preferably between 150 and 800, even more preferably between 200 and 600 ppm, of hypochlorous acid and/or hypochlorite.
   19. A storage-stable aqueous solution according to any of embodiments 15 to 18, characterized in that the molar ratio between hypochlorous acid and/or hypochlorite and chloride ions in the storage-stable solution is 1:1.2 to 1:2.8, preferably 1:1 to 1:1.5 to 1:2.5, even more preferably 1:1.7 to 1:2.1.
   20. A storage-stable aqueous solution according to any of embodiments 15 to 19, characterized in that the storage-stable aqueous solution comprises chlorate at a concentration of less than 50 ppm, preferably of less than 40 ppm, even more preferably of less than 30 ppm, even more preferably of less than 25 ppm, even more preferably of less than 20 ppm.
   21. A method of producing a storage-stable aqueous solution comprising hypochlorous acid and/or hypochlorite, comprising the steps of:
a. introducing an aqueous NaCl solution into an electrolytic cell (1) which comprises a cathode compartment (2) and an anode compartment (3), which are separated from each other by a separator (4), wherein the aqueous NaCl solution is introduced into the cathode compartment (2) via a first feed line (5) and into the anode compartment (3) via a second feed line (6), and wherein the aqueous NaCl solution comprises more than 100 ppm NaCl,
b. applying a direct current to a cathode in the cathode compartment (2) and to an anode in the anode compartment (3) to produce a cathode solution in the cathode compartment (2) and an anode solution in the anode compartment (3), and
c. mixing a portion of the cathode solution with the aqueous NaCl solution before introducing it into the anode compartment (3) and/or with the anode solution in the anode compartment (3) and/or with the anode solution in a discharge line (7) associated with the anode compartment (3), or adding an NaOH solution into the anode compartment (3) and/or into a discharge line (7) associated with the anode compartment (3),
   in order to produce a storage-stable aqueous solution comprising hypochlorous acid and/or hypochlorite that has a pH value of 5 to 6 and can be discharged via the discharge line (7), wherein the introduction of the aqueous NaCl solution into the electrolytic cell (1) and the discharge of the storage-stable aqueous solution from the electrolytic cell (1) occur at a flow rate of 0.1 m/s to 2 m/s.
   22. A method according to embodiment 21, characterized in that the aqueous NaCl solution has an electrical conductivity of less than 30 mS/cm, preferably of 1 to 30 mS/cm, even more preferably of 5 to 30 mS/cm, even more preferably of 10 to 30 mS/cm.
   23. A method according to embodiment 21 or 22, characterized in that the aqueous NaCl solution comprises 200 to 2000 ppm, preferably 300 to 1500 ppm, even more preferably 300 to 1000 ppm, even more preferably 300 to 700 ppm, of NaCl.
   24. A method according to any of embodiments 21 to 23, characterized in that the aqueous NaCl solution has an evaporation residue of 1200 to 2000 mg/l, preferably of 1300 to 1900 mg/l, even more preferably of 1400 to 1800 mg/l.
   25. A method according to embodiment 21 or 22, characterized in that the aqueous NaCl solution comprises 2000 to 15000 ppm, preferably 3000 to 15000 ppm, even more preferably 4000 to 12000 ppm, even more preferably 5000 to 10000 ppm, of NaCl.
   26. A method according to any of embodiments 21, 22 or 25, characterized in that the aqueous NaCl solution has an evaporation residue of 2 to 15 g/l, preferably of 3 to 15 g/l, even more preferably of 5 to 15 g/l, even more preferably of 5 to 10 g/l.
   27. A method according to any of embodiments 21 to 26, characterized in that the aqueous NaCl solution is prepared by mixing a saturated aqueous NaCl solution and water, the water having a conductivity of less than 2 mS/cm, preferably of less than 1.5 mS/cm, even more preferably of less than 1 mS/cm.
   28. A method according to embodiment 27, characterized in that the water has an electrical conductivity of between 0.1 and 2 mS/cm, preferably of between 0.2 and 1.5 mS/cm, even more preferably of between 0.4 and 1 mS/cm.
   29. A method according to embodiment 27 or 28, characterized in that the water has an evaporation residue of 5 to 500 mg/l, preferably of 5 to 300 mg/l, even more preferably of 10 to 250 mg/l.
   30. A method according to any of embodiments 21 to 29, characterized in that the aqueous NaCl solution and/or the water has/have a pH value of 6.8 to 9.5, preferably of 7 to 9.2.
   31. A method according to any of embodiments 21 to 30, characterized in that the aqueous NaCl solution and/or the water has/have 10 to 500 ppm, preferably 20 to 400 ppm, even more preferably 30 to 300 ppm, even more preferably 40 to 250 ppm, of carbonate ions.
   32. A method according to any of embodiments 21 to 31, characterized in that the aqueous NaCl solution comprises less than 0.3 ppm, preferably less than 0.25 ppm, even more preferably less than 0.2 ppm, of copper ions, nickel ions and/or iron ions, and/or less than 0.02 ppm, preferably less than 0.01 ppm, of nitrate ions and/or nitrite ions, and/or less than 500 ppm, preferably less than 400 ppm, even more preferably less than 300 ppm, of sulfate ions, phosphate ions and/or orthosilicate ions, and/or less than 50 ppm, preferably less than 40 ppm, even more preferably less than 30 ppm, even more preferably less than 20 ppm, of calcium ions and/or magnesium ions.
   33. A method according to any of embodiments 21 to 32, characterized in that the aqueous NaCl solution comprises 20 to 200 ppm, preferably 50 to 100 ppm, of an inorganic buffer.
   34. A method according to embodiment 33, characterized in that the inorganic buffer comprises hydrogen carbonate.
   35. A method according to any of embodiments 21 to 34, characterized in that the introduction of the aqueous NaCl solution into the electrolytic cell (1) and the discharge of the storage-stable aqueous solution from the electrolytic cell (1) occur at a flow rate of 0.2 m/s to 1.8 m/s, preferably of 0.2 m/s to 1.5, even more preferably of 0.2 m/s to 1.2, even more preferably of 0.2 m/s to 1 m/s.
   36. A method according to any of embodiments 21 to 35, characterized in that the electrolytic cell (1) is brought to a temperature of 2° C. to 20° C., preferably of 3° C. to 15° C., even more preferably of 5° C. to 10° C., during the method.
   37. A method according to any of embodiments 21 to 36, characterized in that the molar ratio between chlorate ions and hypochlorous acid and/or hypochlorite in the storage-stable solution immediately after its production and/or discharge from the electrolytic cell (1) is less than 1:50, preferably less than 1:60, even more preferably less than 1:80.
   38. A storage-stable aqueous solution comprising hypochlorous acid and/or hypochlorite, preferably producible using a method according to any of embodiments 21 to 37.
   39. A storage-stable aqueous solution according to embodiment 38, characterized in that the storage-stable solution has an electrical conductivity of less than 4 mS/cm, preferably of less than 3 mS/cm, even more preferably of less than 2.5 mS/cm.
   40. A storage-stable aqueous solution according to embodiment 38 or 39, characterized in that the storage-stable solution has an electrical conductivity of 0.5 to 4 mS/cm, preferably of 1 to 3 mS/cm, even more preferably of 1.2 to 3 mS/cm, even more preferably of 1.4 to 2.5 mS/cm.
   41. A storage-stable aqueous solution according to any of embodiments 38 to 40, characterized in that the storage-stable solution comprises between 50 and 1500 ppm, preferably between 100 and 1000, even more preferably between 150 and 800, even more preferably between 200 and 600 ppm, of hypochlorous acid and/or hypochlorite.
   42. A storage-stable aqueous solution according to any of embodiments 38 to 41, characterized in that the molar ratio between hypochlorous acid and/or hypochlorite and chloride ions in the storage-stable solution is 1:1.2 to 1:2.8, preferably 1:1 to 1:1.5 to 1:2.5, even more preferably 1:1.7 to 1:2.1.
   43. A storage-stable aqueous solution according to any of embodiments 37 to 41, characterized in that the molar ratio between chlorate ions and hypochlorous acid and/or hypochlorite in the storage-stable solution is less than 1:10, preferably less than 1:20, even more preferably less than 3:100.
   44. A storage-stable aqueous solution according to any of embodiments 37 to 41, characterized in that the molar ratio between chlorate ions and hypochlorous acid and/or hypochlorite in the storage-stable solution increases from less than 1:60 to a maximum of 1:10 after 18 months of storage at 22° C.
   45. A storage-stable aqueous solution according to any of embodiments 37 to 44, characterized in that the storage-stable aqueous solution comprises chlorate at a concentration of less than 50 ppm, preferably of less than 40 ppm, even more preferably of less than 30 ppm, even more preferably of less than 25 ppm, even more preferably of less than 20 ppm.

### EXAMPLES

### Material & Methods

### Determination of Storage Stability

In order to be able to test the long-term stability or, respectively, the storage stability of a product in an accelerated process, normal long-term ageing is simulated by heating the product over a certain period of time. This test provides reliable data with regard to the storage stability of a product. For implementing the test, a product sample is placed in a glass bottle, then sealed and heated in a heating cabinet at a constant temperature for a defined time. The determination of the storage stability was conducted in these examples according to the CIPAC MT46.3 method (CIPAC; Collaborative International Pesticides Analytical Council).

In the following examples, in which the influence of various parameters on the stability of hypochlorous acid or, respectively, hypochlorite was investigated, approx. 500 ml of the respective samples were placed in one glass bottle each, which subsequently was sealed with a lid comprising a polyethylene insert. The sealed glass bottles were placed in an oven at a temperature of 54° C. (+/−2° C.) for a maximum of 14 days. At the beginning, i.e., before filling the samples into the bottles, after 2 days, after 7 days and after 14 days, the glass bottles were removed from the oven and allowed to cool to room temperature. Afterwards, the aged solutions from the glass bottles were examined.

### Determination of Free Available Chlorine

The concentration of free available chlorine in the samples was determined using the method in accordance with DIN EN ISO 7939-1. In doing so, the pH value of the sample solutions was adjusted to approx. 6.2 to 6.5 and mixed with N,N-diethyl-1,4-phenylenediamine (DPD). As a result of the addition of DPD, the sample solution turned red. The content of free available chlorine was determined by subsequent titration with a standard solution of ammonium iron (II) sulfate until the red colour disappeared.

The content of free available chlorine was determined by multiplying the content of hypochlorous acid or, respectively, hypochlorite by a factor of 0.74.

### Example 1: Influence of the pH Value on the Storage Stability of the Aqueous Solution According to the Invention

In order to investigate the influence of the pH value on the storage stability of the aqueous solution comprising hypochlorous acid or, respectively, hypochlorite, solutions were prepared using the method according to the invention. The pH value of the solutions was adjusted, in each case, to 4, 5, 6, 7 and 7.4 by adding the cathode solution to the anode solution. These solutions were subjected to the ageing procedure described above. In doing so, the temperature of the solutions in the gas bottles was kept constant at 54° C., and the concentrations of free available chlorine and thus of hypochlorous acid or, respectively, hypochlorite were determined prior to the ageing procedure, after 2, 7 and 14 days. To prepare the solutions comprising hypochlorous acid or, respectively, hypochlorite, distilled water was used in each process step. Electrolysis was performed at 20 volts and 60 amperes direct current. The flow rate was 0.8 m/s. The measured values are listed in the following table:

TABLE A

| | pH 4 | | pH 5 | | pH 6 | | pH 7 | | pH 7.4 | |
|---|---|---|---|---|---|---|---|---|---|---|
| | Cl₂ | ΔFAC | Cl₂ | ΔFAC | Cl₂ | ΔFAC | Cl₂ | ΔFAC | Cl₂ | v |
| Day | [ppm] | [%] | [ppm] | [%] | [ppm] | [%] | [ppm] | [%] | [ppm] | [%] |
| 0 | 539 | 100 | 537 | 100 | 550.5 | 100 | 504 | 100 | 496 | 100 |
| 2 | 450 | 83 | 530 | 98.7 | 491.5 | 89 | 364.5 | 72 | 350 | 71 |
| 7 | 420 | 78 | 470 | 88.0 | 450.5 | 81 | 271.5 | 54 | 230 | 46 |
| 14 | 370 | 69 | 400 | 74.5 | 442.5 | 80 | 232 | 46 | 169.5 | 34 |

From Table A, it can clearly be seen that, by adjusting the pH value to pH 5 to 6, a significantly higher storage stability can be achieved with regard to the degradation of hypochlorous acid or, respectively, hypochlorite. Adjusting the pH value is crucial for enabling the production of a storage-stable aqueous solution.

In addition to the content of free available chloride (FAC), the chlorate content was measured in accordance with ISO 10304-4. In doing so, it was surprisingly established that said content was below 50 ppm for all samples with pH 5 and 6. Up until day 7, the chlorate content at pH 5 and 6 was even less than 20 ppm. In contrast, a chlorate content of at least 50 ppm was occasionally determined by ion chromatography in the samples with pH 7 and 7.4 already from day 0 and day 2.

### Example 2: Influence of Carbonate Hardness on the Storage Stability of the Aqueous Solution

The carbonate hardness, expressed by the concentration of HCO₃⁻ present, of the water used in the method or, respectively, of the NaCl solution used, can also influence the storage stability of the solution produced using the method according to the invention with regard to the degradation of the hypochlorous acid or, respectively, the hypochlorite. Therefore, distilled water comprising different concentrations of HCO₃⁻ (added in the form of sodium hydrogen carbonate) was used for preparing the NaCl-containing electrolysis solution. The pH value of the prepared aqueous solution was adjusted to approx. 6.5—as described in Example 1. The solution produced by electrolysis was subjected to an accelerated ageing procedure, as described in Example 1. The temperature was kept constant at 54° C. during the stability test. The FAC measurements were conducted after 0 and 14 days.

TABLE B

| HCO₃⁻ [ppm] | ΔFAC [%] |
|---|---|
| 0 | 0.36 |
| 50 | 0.26 |
| 100 | 0.31 |
| 250 | 0.38 |
| 500 | 0.67 |

Table B shows the change in FAC expressed in % after 2 weeks of storage at 54° C., as described above. The results show that the amount of HCO₃⁻ present can influence the storage stability of the solutions produced according to the invention, whereby the stability can possibly be increased additionally.

### Example 3: Influence of Various Anions and Cations on the Storage Stability of the Aqueous Solution

To investigate the influence of various anions and cations on the storage stability of an aqueous solution produced according to the invention by electrolysis, electrolysis solutions with different concentrations of copper, nickel, iron, calcium, magnesium, nitrate, nitrite, sulfate, phosphate and orthosilicate ions were prepared. For this purpose, distilled water was mixed, in addition to NaCl, with different concentrations of the ions mentioned herein in the form of chloride or, respectively, sodium salts and was subsequently introduced into the anode and cathode compartments of an electrolytic cell and was subjected to electrolysis, as described in Example 1. The aqueous solutions produced in this way, which had a pH value of approx. 6, were subjected to an accelerated ageing procedure, as described in Example 1. The temperature was kept constant at 54° C., and, after 14 days, the change in FAC present was compared with a product according to Example 1 with pH 6 (“reference”).

TABLE C

| | | |
|---|---|---|
| Anion/cation | concentration | score |

| | | | |
|---|---|---|---|
| NO₃₋ | 5 | ppb | n |
| NO₃₋ | 20 | ppb | j |
| NO₃₋ | 50 | ppb | j |
| NO₂₋/NO₃₋ | 10/10 | ppb | j |
| NO₂₋/ | 5 | ppb | n |
| Fe³⁺ | 150 | ppb | n |
| Fe³⁺ | 250 | ppb | j |
| Ni²⁺ | 500 | ppb | j |
| Cu²⁺ | 100 | ppb | n |
| Cu²⁺ | 500 | ppb | j |
| Cu²⁺/Fe | 50/50 | ppb | n |
| Cu²⁺/Fe/Ni²⁺ | 50/50/50 | ppb | n |
| Ni²⁺ | 100 | ppb | n |
| SO₄²⁻ | 200 | ppm | n |
| SO₄²⁻ | 450 | ppm | j |
| PO₄²⁻ | 200 | ppm | n |
| SiO₄²⁻ | 100 | ppm | n |
| SiO₄²⁻ | 500 | ppm | j |
| SiO₄²⁻/SO₄²⁻/PO₄²⁻ | 100/100/100 | ppm | n |
| SiO₄²⁻/SO₄²⁻/PO₄²⁻ | 200/250/300 | ppm | j |
| Ca²⁺ | 10 | ppm | n |
| Ca²⁺ | 20 | ppm | n |
| Ca²⁺ | 40 | ppm | j |
| Mg²⁺ | 10 | ppm | n |
| Mg²⁺ | 20 | ppm | n |
| Mg²⁺ | 40 | ppm | j |
| Ca²⁺/Mg²⁺ | 10/5 | ppm | n |
| Ca²⁺/Mg²⁺ | 20/5 | ppm | n |
| Ca²⁺/Mg²⁺ | 20/10 | ppm | j |

n . . . no or +/− 10% FAC change compared to reference
j . . . decrease in FAC >10% compared to reference

### Example 4: Influence of the Flow Rate on the Storage Stability of the Aqueous Solution

During the electrolysis for the production of the solutions according to the invention, the saline solution is introduced into the anode and cathode compartments at a specific flow rate. The aqueous solution according to the invention comprising hypochlorous acid or, respectively, hypochlorite is obtained from the anode compartment at the same flow rate. To investigate the influence of the flow rate on the storage stability of the electrolysis product during electrolysis, the electrolysis was carried out at different flow rates, as described in Example 1. The electrolysis products were subjected to an accelerated ageing procedure, as described in Example 1. The flow rates when introducing and discharging the storage-stable aqueous solution into and from the electrolytic cell varied between 0.61 m/s and 0.88 m/s. The temperature during the stability test was kept constant at 54° C., and the content of FAC and chlorate was determined after 0 and 14 days. Distilled water was used for preparing the electrolysis solutions.

TABLE D

| | | | FAC | ratio | Delta FAC | Delta | chlorate after |
|---|---|---|---|---|---|---|---|
| Sample | m/s | pH | [ppm] | ClO₃/FAC | 52° C./14 d | chlorate | 14 d/54° C. [ppm] |
| pH5-1 | 0.61 | 5 | 499 | 0.04 | 0.28 | 1.544 | 31 |
| pH5-2 | 0.79 | 5 | 511 | 0.034 | 0.25 | 1.65714 | 29 |
| pH5-3 | 0.88 | 5 | 488 | 0.028 | 0.23 | 1.88406 | 26 |
| pH6-1 | 0.61 | 6 | 526 | 0.042 | 0.37 | 1.72727 | 38 |
| pH6-2 | 0.79 | 6 | 517 | 0.033 | 0.32 | 1.90751 | 33 |
| pH6-3 | 0.88 | 6 | 504 | 0.031 | 0.29 | 1.81818 | 28 |
| pH7-1 | 0.61 | 7 | 476 | 0.062 | 0.54 | 4.91422 | 145 |
| pH7-2 | 0.79 | 7 | 477 | 0.05 | 0.5 | 5.71225 | 135 |
| pH7-3 | 0.88 | 7 | 480 | 0.04 | 0.47 | 6.31579 | 120 |

Table D shows that the flow rate has an additional influence on the storage stability of the electrolysis product and can lead to an even more stable product. It has been shown that increasing the flow rate leads to a more stable product which has a lower chlorate concentration.

1. A method of producing a storage-stable aqueous solution comprising hypochlorous acid and/or hypochlorite, comprising the steps of:
a. introducing an aqueous NaCl solution into an electrolytic cell (1) which comprises a cathode compartment (2) and an anode compartment (3), which are separated from each other by a separator (4), wherein the aqueous NaCl solution is introduced into the cathode compartment (2) via a first feed line (5) and into the anode compartment (3) via a second feed line (6), and wherein the aqueous NaCl solution comprises more than 100 ppm NaCl,
b. applying a direct current to a cathode in the cathode compartment (2) and to an anode in the anode compartment (3) to produce a cathode solution in the cathode compartment (2) and an anode solution in the anode compartment (3), and
c. mixing a portion of the cathode solution with the aqueous NaCl solution before introducing it into the anode compartment (3) and/or with the anode solution in the anode compartment (3) and/or with the anode solution in a discharge line (7) associated with the anode compartment (3), or adding an NaOH solution into the anode compartment (3) and/or into a discharge line (7) associated with the anode compartment (3),
in order to produce a storage-stable aqueous solution comprising hypochlorous acid and/or hypochlorite that has a pH value of 5 to 6 and can be discharged via the discharge line (7).

2. A method of producing a storage-stable aqueous solution comprising hypochlorous acid and/or hypochlorite, comprising the steps of:
a. introducing an aqueous NaCl solution into an electrolytic cell (1) which comprises a cathode compartment (2) and an anode compartment (3), which are separated from each other by a separator (4), wherein the aqueous NaCl solution is introduced into the cathode compartment (2) via a first feed line (5) and into the anode compartment (3) via a second feed line (6), and wherein the aqueous NaCl solution comprises more than 100 ppm NaCl,
b. applying a direct current to a cathode in the cathode compartment (2) and to an anode in the anode compartment (3) to produce a cathode solution in the cathode compartment (2) and an anode solution in the anode compartment (3), and
c. mixing a portion of the cathode solution with the aqueous NaCl solution before introducing it into the anode compartment (3) and/or with the anode solution in the anode compartment (3) and/or with the anode solution in a discharge line (7) associated with the anode compartment (3), or adding an NaOH solution into the anode compartment (3) and/or into a discharge line (7) associated with the anode compartment (3),
in order to produce a storage-stable aqueous solution comprising hypochlorous acid and/or hypochlorite that has a pH value of 5 to 6 and can be discharged via the discharge line (7), wherein the introduction of the aqueous NaCl solution into the electrolytic cell (1) and the discharge of the storage-stable aqueous solution from the electrolytic cell (1) occur at a flow rate of 0.1 m/s to 2 m/s.

3. A method according to claim 1, wherein the aqueous NaCl solution has an electrical conductivity of less than 30 mS/cm, preferably of less than 5 mS/cm.

4. A method according to claim 1, wherein the aqueous NaCl solution has an electrical conductivity of 1 to 30 mS/cm, preferably of 5 to 30 mS/cm, even more preferably of 10 to 30 mS/cm.

5. A method according to claim 1, wherein the aqueous NaCl solution comprises 2000 to 15000 ppm, preferably 3000 to 15000 ppm, even more preferably 4000 to 12000 ppm, even more preferably 5000 to 10000 ppm, of NaCl.

6. A method according to claim 1, wherein the aqueous NaCl solution has an evaporation residue of 2 to 15 g/l, preferably of 3 to 15 g/l, even more preferably of 5 to 15 g/l, even more preferably of 5 to 10 g/l.

7. A method of producing a storage-stable aqueous solution comprising hypochlorous acid and/or hypochlorite, comprising the steps of:
a. introducing an aqueous NaCl solution into an electrolytic cell (1) which comprises a cathode compartment (2) and an anode compartment (3), which are separated from each other by a separator (4), wherein the aqueous NaCl solution is introduced into the cathode compartment (2) via a first feed line (5) and into the anode compartment (3) via a second feed line (6), and wherein the aqueous NaCl solution comprises more than 100 ppm NaCl and has an electrical conductivity of less than 5 mS/cm,
b. applying a direct current to a cathode in the cathode compartment (2) and to an anode in the anode compartment (3) to produce a cathode solution in the cathode compartment (2) and an anode solution in the anode compartment (3), and
c. mixing a portion of the cathode solution with the aqueous NaCl solution before introducing it into the anode compartment (3) and/or with the anode solution in the anode compartment (3) and/or with the anode solution in a discharge line (7) associated with the anode compartment (3),
in order to produce a storage-stable aqueous solution comprising hypochlorous acid and/or hypochlorite that has a pH value of 5 to 6 and can be discharged via the discharge line (7).

8. A method according to claim 7, wherein the aqueous NaCl solution has an electrical conductivity of 1 to 5 mS/cm, even more preferably of 1.5 to 4.5 mS/cm, even more preferably of 2 to 4 mS/cm, even more preferably of 2.5 to 4 mS/cm.

9. A method according to claim 7, wherein the aqueous NaCl solution comprises 200 to 2000 ppm, preferably 300 to 1500 ppm, even more preferably 300 to 1000 ppm, even more preferably 300 to 700 ppm, of NaCl.

10. A method according to claim 7, wherein the aqueous NaCl solution has an evaporation residue of 1200 to 2000 mg/l, preferably of 1300 to 1900 mg/l, even more preferably of 1400 to 1800 mg/l.

11. A method according to claim 1, wherein the introduction of the aqueous NaCl solution into the electrolytic cell (1) and the discharge of the storage-stable aqueous solution from the electrolytic cell (1) occur at a flow rate of 0.1 m/s to 2 m/s, preferably of 0.12 m/s to 1.8 m/s, even more preferably of 0.1 m/s to 1 m/s, even more preferably of 0.2 m/s to 1.5 m/s, even more preferably of 0.2 m/s to 1.2, even more preferably of 0.2 m/s to 1.0 m/s.

12. A method according to claim 1, wherein the aqueous NaCl solution is prepared by mixing a saturated aqueous NaCl solution and water, the water having a conductivity of less than 2 mS/cm, preferably of less than 1.5 mS/cm, even more preferably of less than 1 mS/cm.

13. A method according to claim 12, characterized in that the water has an electrical conductivity of between 0.1 and 2 mS/cm, preferably of between 0.2 and 1.5 mS/cm, even more preferably of between 0.4 and 1 mS/cm.

14. A method according to claim 1, wherein the water has an evaporation residue of 5 to 500 mg/l, preferably of 5 to 300 mg/l, even more preferably of 10 to 250 mg/l.

15. A method according to claim 1, wherein the aqueous NaCl solution and/or the water has/have a pH value of 6.8 to 9.5, preferably of 7 to 9.2.

16. A method according to claim 1, wherein the aqueous NaCl solution and/or the water has/have 10 to 500 ppm, preferably 20 to 400 ppm, even more preferably 30 to 300 ppm, even more preferably 40 to 250 ppm, of carbonate ions.

17. A method according to claim 1, wherein the aqueous NaCl solution comprises less than 0.3 ppm, preferably less than 0.25 ppm, even more preferably less than 0.2 ppm, of copper ions, nickel ions and/or iron ions, and/or less than 0.02 ppm, preferably less than 0.01 ppm, of nitrate ions and/or nitrite ions, and/or less than 500 ppm, preferably less than 400 ppm, even more preferably less than 300 ppm, of sulfate ions, phosphate ions and/or orthosilicate ions, and/or less than 50 ppm, preferably less than 40 ppm, even more preferably less than 30 ppm, even more preferably less than 20 ppm, of calcium ions and/or magnesium ions.

18. A method according to claim 1, wherein the aqueous NaCl solution comprises 20 to 200 ppm, preferably 50 to 100 ppm, of an inorganic buffer.

19. A method according to claim 18, characterized in that the inorganic buffer comprises hydrogen carbonate.

20. A method according to claim 1, wherein that the electrolytic cell (1) is brought to a temperature of 2° C. to 20° C., preferably of 3° C. to 15° C., even more preferably of 5° C. to 10° C., during the method.

21. A method according to claim 1, wherein the molar ratio between chlorate ions and hypochlorous acid and/or hypochlorite in the storage-stable solution immediately after its production and/or discharge from the electrolytic cell (1) is less than 1:50, preferably less than 1:60, even more preferably less than 1:80.

22. A storage-stable aqueous solution comprising hypochlorous acid and/or hypochlorite, producible using a method according to claim 1.

23. A storage-stable aqueous solution according to claim 22, characterized in that the storage-stable solution has an electrical conductivity of less than 4 mS/cm, preferably of less than 3 mS/cm, even more preferably of less than 2.5 mS/cm.

24. A storage-stable aqueous solution according to claim 22, wherein the storage-stable solution has an electrical conductivity of 0.5 to 4 mS/cm, preferably of 1 to 3 mS/cm, even more preferably of 1.2 to 3 mS/cm, even more preferably of 1.4 to 2.5 mS/cm.

25. A storage-stable aqueous solution according to claim 22, wherein the storage-stable solution comprises between 50 and 1500 ppm, preferably between 100 and 1000, even more preferably between 150 and 800, even more preferably between 200 and 600 ppm, of hypochlorous acid and/or hypochlorite.

26. A storage-stable aqueous solution according to claim 22, wherein the molar ratio between hypochlorous acid and/or hypochlorite and chloride ions in the storage-stable solution is 1:1.2 to 1:2.8, preferably 1:1 to 1:1.5 to 1:2.5, even more preferably 1:1.7 to 1:2.1.

27. A storage-stable aqueous solution according to claim 22, wherein the molar ratio between chlorate ions and hypochlorous acid and/or hypochlorite in the storage-stable solution is less than 1:10, preferably less than 1:20, even more preferably less than 3:100.

28. A storage-stable aqueous solution according to claim 22, wherein the molar ratio between chlorate ions and hypochlorous acid and/or hypochlorite in the storage-stable solution increases from less than 1:60 to a maximum of 1:10 after 18 months of storage at 22° C.

29. A storage-stable aqueous solution according to claim 22, wherein the storage-stable aqueous solution comprises chlorate at a concentration of less than 50 ppm, preferably of less than 40 ppm, even more preferably of less than 30 ppm, even more preferably of less than 25 ppm, even more preferably of less than 20 ppm.
